(19) United States
(12) Patent Application Publication
(10) Pub. No.: US 2009/0136833 A1
(43) Pub. Date: May 28, 2009

(54) CASE FILM FOR POUCH TYPE LITHIUM PRIMARY BATTERY

(75) Inventors: Young-Gi LEE, Daejeon-city (KR); Kwang Man KIM, Daejeon-city (KR); Jae-Young JUNG, Daejeon-city (KR); Heyung Sub LEE, Daejeon-city (KR); Cheol Sig PYO, Daejeon-city (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, DAEJEON-CITY (KR)

(21) Appl. No.: 12/132,832

(22) Filed: Jun. 4, 2008

(30) Foreign Application Priority Data
Nov. 27, 2007 (KR) 10-2007-0121405

(51) Int. Cl. H01M 2/02

(52) U.S. Cl. 429/122

(57) ABSTRACT

Provided is a case film for a pouch type lithium primary battery which is suitable for application in a film type lithium primary battery. The case film for a pouch type lithium primary battery includes a flexible multilayer film in which a first polymer film, a second polymer film, a metal film, and a third polymer film are sequentially stacked. The first polymer film is formed of a hydrocarbon compound substituted or non-substituted with a halogen atom. The second polymer film is formed of an amorphous or low crystalline polymer having a crystallinity of 0 to 20%. The third polymer film is formed of a crystalline polymer having a crystallinity of 40 to 100%.

### CROSS-REFERENCE TO RELATED PATENT APPLICATION

This application claims the benefit of Korean Patent Application No. 10-2007-0121405, filed on Nov. 27, 2007, in the Korean Intellectual Property Office, the disclosure of which is incorporated herein in its entirety by reference.

### BACKGROUND OF THE INVENTION

1. Field of the Invention

The present invention relates to a pouch type case film, and more particularly, to a case film for a pouch type lithium primary battery having superior flexibility. This work was supported by the Information Technology (IT) Research & Development (R&D) program of the Ministry of Information and Communication (MIC) and the Institute for Information Technology Advancement (IITA) [2006-S-006-03, Development of Sensor Tag and Sensor Node Technologies for RFID/USN]

2. Description of the Related Art

Recently, a technique relating to active type radio frequency identification (RFID) tags and sensor nodes have been actively studied. The consequences of this technique being combined together with digital TVs, home net works and intelligent robots is enormous, and may exceed the conventional technique of Code Division Multiple Access (CDMA). Thus, this new technique is expected to be a core part of the electronic industry in the near future. That is, in the technique, a RFID and a sensor node not only greatly increase a tag recognition distance but also senses object information around the tag and atmospheric information beyond the conventional passive function of reading information recorded in a tag through a reader. Thus, eventually, it is expected that the region of information flow can be expanded from communication between humans and objects, to communication between objects through a network.

In order to drive the RFID and the sensor node, it is important to provide a completely independent power source separated from a reader by employing a power source device that is ultra small in size, light, and has a long lifetime suitable for the specifications of a RFID tag and a sensor node. Also, when considering that the field of application of RFID tags has been expanded from pallets which transport luggage, to items such as various commodities, and also, the a RFID tag is discarded once the aim of use is achieved, a primary battery that is not required to be exchanged or recharged may be applied.

Up to now, a film primary battery, applied to some RFID tags, proving the possibility of using a primary battery as the power source. The film primary battery is a kind of Mn battery having an output voltage of 1.5V. The film primary battery has a configuration of electrodes and an electrolyte identical to a conventional dry cell, and is restructured to a laminated film shape using a polyethylene terephtalate (PET) group packing material instead of a cylindrical can. The PET film has a low oxygen permeability, and thus, superior oxygen blocking characteristics, however, has a relatively large hydrophilic property compared to a polyolefin group material due to the presence of an ester group on a surface of the PET film. Thus, the PET film has a drawback in that the permeability of moisture and oxygen increases when an excessive amount of moisture is present around the PET film. In some cases, moisture contained in an electrolyte penetrates into the PET film and can vaporize and allow leakage. Also, since the PET film has a low resistance to strong acids and alkalis, the PET film can corrode when the PET film contacts the electrolyte. Such drawbacks severely affect the durability, long term charge conservation, and lifetime of the film primary battery, and thus, rapidly reduce the performance of the film primary battery.

As the function of RFID tags develops from a semi-active type to an active type, a sensor is attached to the tag, and thus, a driving voltage of the tag is increased to 3V. Thus, in the case when conventional film primary batteries are used, the conventional film primary batteries must be connected in series. This eventually leads to an increase of volume occupied by the batteries in a spatially limited tag without increasing energy density. In order to address the above problems, a lithium group primary battery must be applied to the film primary battery. That is, instead of a configuration in which 1.5V batteries are connected in series, the energy density per unit volume must be increased by applying a 3V unit cell using a lithium foil as a cathode.

However, if lithium is used as a cathode, when the battery is exposed to moisture, the battery can ignite or explode since the lithium is sensitive to moisture. That is, as the battery is converted to a 3V lithium primary battery, the highly explosive lithium and anhydrous organic electrolyte are applied in the battery, and thus, the safety of the unit cell must be secured by tightly sealing the battery from external air or moisture.

### SUMMARY OF THE INVENTION

To address the above and/or other problems, the present invention provides a case film for a pouch type lithium primary battery that has a superior blocking effect with respect to moisture and air, has superior bendable and foldable characteristics, has a strength sufficient enough to ensure resistance to damage from bending and folding, can be easily and simply manufactured, and can be mass produced in a completely automated process.

According to an aspect of the present invention, there is provided a case film for a pouch type lithium primary battery includes a flexible multilayer film in which a first polymer film, a second polymer film, a metal film, and a third polymer film are sequentially stacked. The first polymer film is formed of a hydrocarbon compound substituted or non-substituted with a halogen atom. The second polymer film is formed of an amorphous or low crystalline polymer having a crystallinity of 0 to 20%. The third polymer film is formed of a crystalline polymer having a crystallinity of 40 to 100%.

The first polymer film, the second polymer film, and the third polymer film may be each formed of different materials from each other.

The first polymer film and the second polymer film, the second polymer film and the metal film, and the metal film and the third polymer film respectively may be bonded to each other by polymer bonding layers.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view showing a configuration of a case film for a pouch type lithium primary battery according to an embodiment of the present invention.

### DETAILED DESCRIPTION OF THE INVENTION

The present invention will now be described more fully with reference to the accompanying drawings in which exemplary embodiments of the invention are shown.

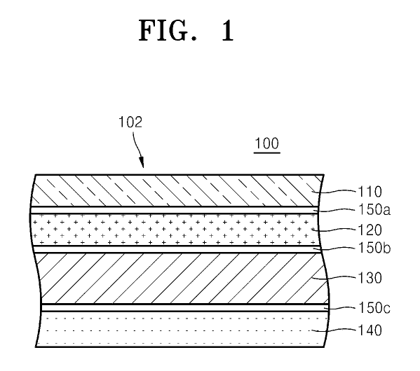

FIG. 1 is a cross-sectional view showing a configuration of a case film 100 for a pouch type lithium primary battery according to an embodiment of the present invention.

Referring to FIG. 1, the case film 100 for a pouch type lithium primary battery is a flexible multilayer film 102 in which a first polymer film 110, a second polymer film 120, a metal film 130, and a third polymer film 140 are sequentially stacked.

The first polymer film 110 is formed of a hydrocarbon compound substituted with a halogen atom or a hydrocarbon formed of only carbon and hydrogen. For example, the first polymer film 110 can be formed of at least one selected from the group consisting of polytetrafluoroethylene, polystyrene, and polyvinylidene chloride, a polymer blend of at least two selected from the above material group, or a co-polymer of at least two selected from the above material group.

The first polymer film 110 has strong hydrophobic characteristics since the first polymer film 110 is formed of elements of C and H or elements of C, H, and a halogen. If the first polymer film 110 is formed of a hydrocarbon compound substituted with a halogen atom, it can be non-combustible. Thus, when a pouch case is formed using the case film 100 according to the present embodiment, the first polymer film 110 can be attached to an outermost side of the flexible multilayer film 102 to effectively prevent the penetration and contact of moisture, to prevent the flexible multilayer film 102 from being damaged by bending and folding of the metal film 130, and to improve the flexibility of the flexible multilayer film 102. The first polymer film 110 can be formed to a thickness of 1 to 100 μm.

The second polymer film 120 is formed of an amorphous or low crystalline polymer having a crystallinity of 0 to 20%.

The second polymer film 120 formed of an amorphous polymer can be formed of a material selected from the group consisting of, for example, polyvinyl chloride, polyvinylidene chloride, nylon, polyacrylonitrile, polyvinyl alcohol, and poly(ethylene-co-vinyl alcohol), a polymer blend of at least two selected from the above material group, or a co-polymer of at least two selected from the above material group.

Also, the second polymer film 120 can be formed of a low crystalline polymer selected from the group consisting of polyethylene terephthalate and polybutylene terephthalate (PBT).

The second polymer film 120 performs as a protective film for preventing the metal film 130 from being corroded by the penetration of external moisture and oxygen. Also, the second polymer film 120 can be formed of an insulating material to insulate the metal film 130. The second polymer film 120 can be formed to a thickness of 1 to 100 μm.

The metal film 130 is formed of a metal having superior moisture and air blocking characteristics, a moldability to be molded into a sheet, and characteristics ensuring maintenance of a thin film form. The metal film 130 is formed of at least a material selected from the group consisting of, for example, Al, Cu, stainless steel, Ni, or an alloy of these metals.

The metal film 130 improves the oxygen blocking characteristics and mechanical strength of the flexible multilayer film 102, and can be formed to a thickness of 1 to 100 μm, and preferably, 3 to 6 μm.

The third polymer film 140 is formed of a crystalline polymer having a crystallinity of 40 to 100%. The crystalline polymer having a relatively large crystallinity does not undergo a swelling phenomenon since the crystalline polymer provides high strength at crystallized portions. Thus, the third polymer film 140 can prevent the flexible multilayer film 102 from exfoliation and can increase long term charge conservation of the flexible multilayer film 102. Also, the third polymer film 140 prevents a battery placed in the pouch case formed of the flexible multilayer film 102 from being disconnected. Also, the third polymer film 140 provides superior thermal fusion characteristics at a relatively low temperature so that the battery can be vacuum-packed in a reduced pressure state.

The third polymer film 140 can be formed of a material selected from the group consisting of saran, polyethylene, and polypropylene, a polymer blend of these materials, or a co-polymer of these materials.

The third polymer film 140 can be formed to a thickness of 1 to 100 μm.

The first polymer film 110, the second polymer film 120, the metal film 130, and the third polymer film 140 can be formed of different materials. In some cases, two films selected from the first polymer film 110, the second polymer film 120, and the third polymer film 140 can be formed of the same material.

As depicted in FIG. 1, the first polymer film 110, the second polymer film 120, the metal film 130, and the third polymer film 140 are mutually bonded by a first polymer bonding layer 150a, a second polymer bonding layer 150b, and a third polymer bonding layer 150c respectively interposed therebetween.

The first polymer bonding layer 150a, the second polymer bonding layer 150b, and the third polymer bonding layer 150c can each be formed of a material selected from the group consisting of, for example, polyethylene, polypropylene, polyurethane, and an acrylate-based polymer, or a polymer blend of at least two selected from these materials. Examples of the acrylate-based polymer are polymethylacrylate, polyethylacrylate, polymethylmetacrylate, polyethyemethacrylate, polybutylacrylate, or polybutyl metacrylate.

The first polymer bonding layer 150a, the second polymer bonding layer 150b, and the third polymer bonding layer 150c can each be formed to a thickness of 0.1 to 50 μm.

A method of manufacturing the case film 100 for a pouch type lithium primary battery of FIG. 1 will now be described.

Both surfaces of each of the first polymer film 110, the second polymer film 120, and the third polymer film 140 are treated with corona discharge. The corona discharge facilitates the bonding of the first polymer film 110, the second polymer film 120, and the third polymer film 140 with the first polymer bonding layer 150a, the second polymer bonding layer 150b, and the third polymer bonding layer 150c, respectively, and also, facilitates lamination of each of the first polymer film 110, the second polymer film 120, and the third polymer film 140.

The first polymer film 110, the second polymer film 120, and the third polymer film 140 can be obtained by molding molten resins extruded from an extruder into a film shape. In particular, in order to form the second polymer film 120, a process is employed involving forming a polymer film having an amorphous oriented state by quenching a molten polymer that exists in an amorphous state and has a very low crystallizing speed while extending the molten polymer in an extruder.

After forming the third polymer bonding layer 150c on the third polymer film 140, the metal film 130 is bonded onto the third polymer bonding layer 150c. After forming the second polymer bonding layer 150b on the metal film 130, the second polymer film 120 is bonded onto the second polymer bonding layer 150b. After forming the first polymer bonding layer 150a on the second polymer film 120, the first polymer film 110 is bonded onto the first polymer bonding layer 150a. The manufacture of the flexible multilayer film 102 is completed through the above processes.

The case film 100 for a pouch type lithium primary battery formed of the flexible multilayer film 102 formed as described above has a significantly reduced thickness unlike a conventional Al pouch film, and thus, can bend easily and has increased flexibility. Also, since thermal fusion sealing is possible at a relatively low temperature, a thermal fusion temperature can be reduced. Thus, degradation or decomposition of elements in the film can be prevented during fusion sealing. Also, the flexible multilayer film 102 has superior compression characteristics when vacuum sealing is performed under a reduced pressure condition since the flexible multilayer film 102 is very thin and flexible. The case film 100 for a pouch type lithium primary battery according to the present embodiment can be obtained by repeatedly bonding and laminating the multiple polymer films formed in a film shape and a metal film, and thus, production can easily be automated, and can easily be set up a continuous and mass production process. Also, in the case film 100 for a pouch type lithium primary battery, composite films stacked in various combinations can be readily manufactured according to desired characteristics of a film battery.

Example methods of manufacturing the case film 100 for a pouch type lithium primary battery according to the present invention will now be described more in detail. However, the following manufacturing examples should not be construed as being limited to the embodiments set forth herein; rather, the present invention may, however, be embodied in many different forms from the following manufacturing examples without departing from the spirit and scope of the present invention.

### MANUFACTURING EXAMPLE 1

A polyvinylidene chloride film having a thickness of 5 μm as a first polymer film, a polyethylene terephthalate film having a thickness of 10 μm as a second polymer film, an Al film having a thickness of 30 μm, and a un-extended polypropylene film having a thickness of 30 μm as a third polymer film 140 were prepared, and both surfaces of each of the first through third polymer films were treated with corona discharge. The first through third polymer films were laminated into a flexible multilayer film in which the first through third polymer films were sequentially stacked using polyethylene layers having a thickness of 1 to 5 μm as bonding layers interposed between the first through third polymer films. At this point, the flexible multilayer film was formed to have an overall thickness of 80 μm.

### MANUFACTURING EXAMPLE 2

A flexible multilayer film was manufactured using the same method as in manufacturing example 1 except that a polybutyl terephthalate film having a thickness of 10 μm was used as the second polymer film.

### MANUFACTURING EXAMPLE 3

A flexible multilayer film was manufactured using the same method as in manufacturing example 1 except that a nylon film having a thickness of 10 μm was used as the second polymer film.

### MANUFACTURING EXAMPLE 4

A flexible multilayer film was manufactured using the same method as in manufacturing example 1 except that a polyvinyl alcohol film having a thickness of 10 μm was used as the second polymer film.

### MANUFACTURING EXAMPLE 5

A flexible multilayer film was manufactured using the same method as in manufacturing example 1 except that a poly(ethylene-co-vinyl alcohol) film having a thickness of 10 μm was used as the second polymer film.

### COMPARATIVE EXAMPLE

After preparing a polyethylene terephthalate film having a thickness of 20 μm and an un-extended polypropylene film having a thickness of 40 μm, both surfaces of each of the films were treated with corona discharge. Afterwards, an Al film having a thickness of 50 μm was disposed between the two films, and a multilayer film having an overall thickness of 120 μm was manufactured by introducing polyethylene bonding layers between the films.

### EVALUATION EXAMPLE

Table 1 summarises moldability, bending characteristics, folding characteristics, and thermal fusion characteristics of each of the multilayer films manufactured in the manufacturing examples 1 through 5 and the comparative example.

TABLE 1

| | Comparative | Manufacturing | Manufacturing | Manufacturing | Manufacturing | Manufacturing |
|---|---|---|---|---|---|---|
| Evaluation item | example | Example 1 | Example 2 | Example 3 | Example 4 | Example 5 |
| Moldability | Un-molded | superior | superior | superior | superior | superior |
| Bending | good | superior | superior | superior | superior | superior |
| characteristics | | | | | | |
| Folding | poor | superior | superior | superior | superior | superior |
| characteristics | | | | | | |
| Thermal | 140-150 | 120-130 | 120-130 | 120-130 | 120-130 | 120-130 |
| fusion | | | | | | |
| temperature | | | | | | |
| (° C.) | | | | | | |

In order to measure the moldability shown in Table 1, the multilayer films were molded using a metal molder having a width of 28 mm, a length of 30 mm, and a depth of 1 mm as an oil press, and the moldabilities thereof were observed. The multilayer film of the comparative example cannot be molded to a desired shape when the multilayer film is molded in a shallow mold having a depth of 1 mm since the multilayer film has a relatively large thickness of 120 μm. However, the multilayer films manufactured in the manufacturing examples 1 through 5 show superior moldability, that is, a desired shape is readily molded in a mold having a depth of 1 mm since the multilayer films have a small thickness of 80 μm.

In order to measure the bending characteristics, that is, flexibility, shown in Table 1, after bending the multilayer films obtained in the manufacturing examples 1 through 5 and the comparative example to 90°, bending angle, thickness and area of the bended portion of each of the multilayer films were observed. Since the multilayer films obtained from the manufacturing examples 1 through 5 have a small thickness of 80 μm and the multilayer film obtained from the comparative example has a large thickness of 120 μm, the multilayer films obtained from the manufacturing examples 1 through 5 have a bending characteristic superior to that of the multilayer film obtained from the comparative example. In particular, when each of the multilayer films is bended to 90°, the multilayer film obtained from the comparative example has a wide and non-uniform bending portion. However, in the case of the manufacturing examples 1 through 5, the multilayer films have narrow and uniform bending portions. The bending characteristics of the multilayer film greatly affect the moldability for molding the pouch case film. The better the bending characteristics, the more effectively molding of the pouch case film can be achieved, and thus, a pouch type battery having a favourable shape can be manufactured. Also, the better the bending characteristics, in a pouch type battery, the better the multilayer film can flexibly cope with minute expansion and contraction during charge and discharge of a battery having a multilayer structure in which a plurality of films are laminated.

The folding characteristics shown in Table 1 are the results of evaluation made by observing the multilayer films obtained from the manufacturing examples 1 through 5 and the comparative example when the multilayer films were folded to 180°. The multilayer film that has a relatively large thickness and is obtained from the comparative example does not show a clear trace or a shape of the folded portion after folding the multilayer film to 180° due to its large thickness. However, the multilayer films obtained from the manufacturing examples 1 through 5 maintain thin, sharp, and clear folded traces. The folding characteristics greatly affect the moldability for molding a pouch case film. The better the moldability of the multilayer film, the more effectively molding of the pouch case film can be achieved, and thus, a pouch type battery having a favourable shape can be more readily manufactured.

In Table 1, the thermal fusion temperature indicates a temperature required for obtaining a complete thermally-fused product in a thermal fusion process in which the multilayer films obtained from the manufacturing examples 1 through 5 and the comparative example are vacuum-sealed by thermally fusing the multilayer films after vacuum-pressing the multilayer films to −760 mmHg in a vacuum sealing apparatus. When the multilayer films are thermally fused, a thermal fusion temperature near the melting point of the thermal fusion film or above must be reached since a primary transition of the thermal fusion film, that is, melting of a crystal portion of the thermal fusion film must take place. Also, the larger the thickness of the thermal fusion film, the longer and higher a fusion time and a fusion temperature must be. In the case of the comparative example, the thermal fusion temperature of the multilayer film is in a range from 140 to 150° C. However, in the case of the manufacturing examples 1 through 5, the thermal fusion temperature of the multilayer films is higher by approximately 10° than that of the comparative example. In the case of the multilayer film obtained from the comparative example, the temperature required for heat transfer and fusion was high due to the relatively large thickness. However, in the case of the multilayer films obtained from the manufacturing examples 1 through 5, the fusion occurs at a temperature of 120 to 130° C. which is near the melting point of the multilayer films since heat transfer is easily achieved due to the small thickness of the multilayer films. If the fusion temperature is excessively high, the metal film is heated, and accordingly, temperature in the battery is increased. In this case, due to the high temperature in the battery, polymer bonding materials present in the battery melt leading to various problems such as the degradation of electrode structure, volatilization of an electrolyte, and the degradation of lithium slat in the electrolyte, and eventually reduces the performance and durability of the battery. Thus, it is necessary to reduce the thermal fusion temperature to be as low as possible.

In Table 1, the multilayer films obtained from the manufacturing examples 1 through 5 according to the present invention all show superior moldability, bending characteristics, folding characteristics, and thermal fusion characteristics. This indicates that when the flexible multilayer film according to the present invention is used for a case film for a pouch type lithium primary battery, processability, long term stability, and lifetime characteristics of the case film can be improved.

Since the case film for a pouch type lithium primary battery according to the present invention has superior flexibility, performance degradation due to cell bending caused in a process of applying a tag can be prevented. Also, when a lithium primary battery is sealed using the case film according to the present invention, the degradation or decomposition of an electrolyte and an electrode material due to temperature increase in the battery can be prevented since a thermal fusion for sealing the lithium primary battery can be performed at a low temperature. Also, since the case film for a pouch type lithium primary battery according to the present invention can be formed to be thin, the case film can be effectively employed as a pouch case for a film type lithium primary battery. Also, when the case film is sealed under a reduced pressure condition, since the case film can be readily contracted and strongly compressed and sealed due to the improved flexibility of the case film, a contact resistance between the electrodes and the electrolyte is mitigated. Thus, a lithium primary battery accommodated in the case formed of a film according to the present invention can have increased safety, can ensure long term stability, and can repress the reduction of performance with respect to long term discharge. Also, the case film for a pouch type lithium primary battery has a simple manufacturing process that can be easily automated and can easily be set up a continuous process suitable for mass production

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A case film for a pouch type lithium primary battery, comprising a flexible multilayer film in which a first polymer film, a second polymer film, a metal film, and a third polymer film are sequentially stacked,
wherein the first polymer film is formed of a hydrocarbon compound substituted or non-substituted with a halogen atom,
the second polymer film is formed of an amorphous or low crystalline polymer having a crystallinity of 0 to 20%, and
the third polymer film is formed of a crystalline polymer having a crystallinity of 40 to 100%.

2. The case film of claim 1, wherein the first polymer film, the second polymer film, and the third polymer film are each formed of different materials from each other.

3. The case film of claim 1, wherein the first polymer film is formed of at least one selected from the group consisting of polytetrafluoroethylene, polystyrene, and polyvinylidene chloride, a polymer blend of at least two selected from the above material group, or a co-polymer of at least two selected from the above group.

4. The case film of claim 1, wherein the second polymer film is formed of an amorphous polymer.

5. The case film of claim 1, wherein the second polymer film is formed of a material selected from the group consisting of polyvinyl chloride, polyvinylidene chloride, nylon, polyacrylonitrile, polyvinyl alcohol, and poly(ethylene-co-vinyl alcohol), a polymer blend of at least two selected from the above material group, or a co-polymer of at least two selected from the above group.

6. The case film of claim 1, wherein the second polymer film is formed of a material selected from the group consisting of polyethylene terephthalate and polybutylene terephthalate (PBT).

7. The case film of claim 1, wherein the metal film is formed of a material selected from the group consisting of Al, Cu, stainless steel, and Ni, or an alloy of these metals.

8. The case film of claim 1, wherein the third polymer film is formed of a material selected from the group consisting of saran, polyethylene, and polypropylene, a polymer blend of these materials, or a co-polymer of these materials.

9. The case film of claim 1, wherein the first polymer film and the second polymer film, the second polymer film and the metal film, and the metal film and the third polymer film are respectively bonded to each other by polymer bonding layers.

10. The case film of claim 9, wherein the polymer bonding layers are formed of a material selected from the group consisting of polyethylene, polypropylene, polyurethane, and an acrylate-based polymer, a polymer blend of at least two selected from the above material group, or a co-polymer of at least two selected from the above group.

11. The case film of claim 10, wherein the polymer of the acrylate-based a polymer is one selected from the group consisting of polymethylacrylate, polyethylacrylate, polymethylmetacrylate, polyethylmethacrylate, polybutylacrylate, and polybutylmetacrylate.
